(19) United States
(12) Patent Application Publication
(10) Pub. No.: US 2015/0056562 A1
(43) Pub. Date: Feb. 26, 2015

(54) CANDLE MAGAZINE

(71) Applicants: Lydia KLEFFMANN, Hullhorst (DE); Andrea STEINMEIER, Hullhorst (DE); Linette INDERBIETHEN, Wohltorf (DE)

(72) Inventors: Lydia KLEFFMANN, Hullhorst (DE); Andrea STEINMEIER, Hullhorst (DE); Linette INDERBIETHEN, Wohltorf (DE)

(21) Appl. No.: 14/227,513

(22) Filed: Mar. 27, 2014

(30) Foreign Application Priority Data
Aug. 22, 2013 (DE) 10 2013 216 702.4
Sep. 10, 2013 (DE) 10 2013 218 067.5
Nov. 13, 2013 (DE) 10 2013 223 078.8

(51) Int. Cl. F21V 35/00; B29C 51/10; B29C 39/10; B29C 51/08

(52) U.S. Cl. CPC F21V 35/00; B29C 51/08; B29C 51/10; B29C 39/10; B29K 2091/00
USPC 431/295; 264/510; 425/504

(57) ABSTRACT

A candle magazine has a multiplicity of deep-drawn cup-like structures in which there is provided in each case one candle composed of a combustible material and of a wick. A candle, a method for producing a candle or a candle magazine, and a deep-drawing apparatus are also provided.

### BACKGROUND

The present invention relates to a candle magazine which has a multiplicity of deep-drawn cup-like structures in which there is provided in each case one candle composed of a combustible material and of a wick. The present invention also relates to a candle, to a method for producing a candle or a candle magazine, and to a deep-drawing apparatus.

At present, candles, in particular tealights, are provided in an aluminium container. The production of said candles is however highly cumbersome and a large amount of packaging waste is produced.

### SUMMARY

It is therefore the object of the present invention to provide a candle magazine or a candle that does not have the disadvantages of the prior art.

The object is achieved by means of a candle magazine which has a multiplicity of deep-drawn cup-like structures in which there is provided in each case one candle composed of a combustible material and of a wick.

The statements made regarding this subject of the present invention apply equally to the other subjects of the present invention and vice versa.

The present invention relates to a candle magazine which has a multiplicity of deep-drawn cup-like structures. For this purpose, a planar material web is generally provided which is subsequently deep-drawn under the influence of an elevated temperature and/or pressure and/or vacuum such that the cup-like structure is formed in the material web. A candle is then provided in said cup-like structure, which candle is composed of a combustible material, in particular wax, for example beeswax, stearin and/or paraffin, that is to say in particular hardened or refined vegetable and/or animal fat, wax-like materials and/or technical wax mixtures, and of a wick.

The cross section of the cup-like structure is preferably provided such that the length of the wick that protrudes out of the combustible material is always shorter than the shortest dimension of the cross section of the cup-like structure. This prevents the wick or the flame of the wick from coming into contact with the side wall of the cup-like structure.

Any deep-drawable material may be used as a material for producing the cup-like structure or the magazine. The material from which the cup-like structure or the magazine is produced is preferably a plastic, and the material web is preferably a plastics foil. The material from which the cup-like structure or the magazine is produced may be provided in single-layer or multi-layer form. The material from which the cup-like structure or the magazine is produced may be composed partially or entirely of paper, in particular deep-drawable paper, and/or from cardboard, in particular deep-drawable cardboard. The material from which the depression or the magazine is produced may be composed partially, for example in one layer, of metal, in particular aluminium. The material from which the cup-like structure or the magazine is produced is preferably non-combustible and/or of low flammability. Examples of such materials are:
technical polymers
wood-plastic composites
bioplastics
thermoplastic starches
C-PET
A-PET
PEEK
PTFE
PAI
PVDF
Terratec
Biocellat
paper of low flammability or composite foils of low flammability
composite materials composed of plastics and biomaterial.

The material from which the cup-like structure for the magazine is produced may be transparent and/or coloured. The material may be printed using any desired method. In particular, the material may be transparent and printed with colour. This advantageously makes it possible to provide a substantially transparent cup-like structure or a substantially transparent magazine and nevertheless provide important product information and/or warnings on the cup-like structures.

It is particularly preferable for the material from which the cup-like structure for the magazine is produced to at least partially have a combustible material, in particular a natural raw material, which has starch, for example. In this way, the cup-like structure can be disposed of without residue after the candle has been burned.

In one preferred embodiment, the wick is a filiform mesh. It is particularly preferable for the wick to have a stiffening means, for example a hard wax coating, in particular on its outer side. In this way, it is advantageously possible for the wick to have a certain degree of inherent stability, and/or for the combustion characteristics of said wick to be influenced in a desired way.

In a preferred embodiment, the wick of the candle is directly or indirectly connected to the cup-like structure in positively locking, non-positively locking and/or cohesive fashion. For example, the wick has a wick holder there is preferably connected to the cup-like structure by means of adhesive bonding, sealing, welding or preferably by means of a snap-action fastener. It is however also conceivable for the wick to be connected to the cup-like structure in positively locking, non-positively locking and/or cohesive fashion without a wick holder, for example by pressing-in and/or sealing.

In one preferred embodiment of the present invention, each cup-like structure has a base region in which there is provided a recess and/or protuberance and/or an opening in which the wick and/or a wick holder is fastened. Said fastening is particularly preferably a positively locking, non-positively locking and/or cohesive fastening. The recess or protuberance serves to prevent a displacement of the wick during the production of the candle magazine and/or as the candle is burned. The recess and/or protuberance preferably has an undercut that interacts in positively locking and/or non-positively locking fashion with the wick and/or with the wick holder.

It is furthermore preferable for the base region to be provided so as to be inclined relative to the horizontal at least in sections. It is ensured in this way that the combustible material that liquefies as the candle is burned flows in the direction of the wick such that at least the most complete possible burn-off of the combustible material is ensured.

It is preferable for a predetermined breaking point to be provided between two cup-like structures of the magazine such that the individual cup-like structures can be easily separated off by a user and made available as individual candles.

In one preferred embodiment, the cup-like structure has a means that connects the combustible material to the cup-like structure in positively locking and/or non-positively locking fashion. Said positive locking and/or non-positive locking is preferably such that it holds the candle in the cup-like structure for example during the transportation and/or use of said candle, but can be relatively easily overcome by manual force such that the candle can be removed from the cup-like structure if desired.

The user can use the candles by separating off the individual cup-like structures. It is however also possible for the user to remove the combustible material together with the wick from the depression and to burn the said candle separately from the deep-drawn cup-like structure. This embodiment is preferable in particular in the case of so-called floating candles, refill packs or refill candles.

In one preferred embodiment, the candle magazine has a connection surface to which a cover foil can be fastened, in particular by sealing. By means of this preferred embodiment of the present invention, each cup-like structure is closed off, and the candle situated therein is thereby protected. Furthermore, said cover foil, and also the material from which the cup-like structure or the magazine is manufactured, may be printed with information or branding or the like. The cover foil preferably has a predetermined breaking point between two cup-like structures. The cover foil preferably has, in the region of each cup-like structure, an opening region by which the cover foil can be pulled off from the cup-like structure preferably after the latter has been separated off. The cover foil may be printed using any desired methods.

Alternatively or in addition, the candle magazine as a whole may be provided in a packaging, for example a tubular-bag-type packaging. Said packaging may likewise be printed with branding, product information or the like.

The magazines are particularly preferably designed such that they can be stacked when no candles are situated in the cup-like structures.

The present invention also relates to a candle having a combustible material and a wick, which candle is provided in a deep-drawn cup-like structure.

The statements made regarding this subject of the present invention apply equally to the other subjects of the present invention and vice versa.

The candle according to the invention is simple and inexpensive to produce. The wick of the candle may be connected directly or indirectly to the packaging cup-like structure, and it is preferable for the deep-drawn cup-like structure to be directly filled with the combustible material, with the combustible material hardening in said cup-like structure.

The cup-like structure preferably has a recess for the wick or a wick holder.

The candle preferably has a wick holder, wherein the material from which the wick holder is manufactured is a plastic, metal, or a natural wax, an artificial wax, a wax-like material, and/or a technical wax mixture.

The material from which the wick holder is manufactured is preferably non-combustible and/or of low flammability. It is preferable for the material from which the wick holder is manufactured to be compostable. It is very particularly preferable for the wick holder to be manufactured from the same material as the depression and/or from the same material as the combustible material.

The material from which the wick holder is manufactured is preferably a sealable material, in particular plastic.

The wick holder is preferably provided as a combustion stopper. In this way, it is advantageously possible for the wick to burn only as far as the wick holder, with the flame then being extinguished, such that adverse impairment, in particular a risk of fire, of an underlying surface is eliminated. The wick holder particularly preferably has a flame-extinguishing impregnation, coating and/or shape. It is very particularly preferable for the material from which the wick holder is manufactured to be non-combustible and/or of low flammability.

It is preferable for the wick to be cast or clamped or thermally and/or mechanically connected into the wick holder. A mechanical connection will be understood to mean in particular a positively locking and/or non-positively locking connection.

According to a preferred embodiment, the wick is provided in the form of an endless band, wherein it is particularly preferable for wick holders to be provided, in particular at regular intervals, on the endless band.

The candle is preferably separated off from the candle magazine according to the invention.

The present invention also relates to a method for producing a candle according to the invention, wherein the cup-like structure is deep-drawn from a material web, in particular a plastics foil, the wick is provided in the cup-like structure, and the cup-like structure is filled with the combustible material.

The statements made regarding this subject of the present invention apply equally to the other subjects of the present invention and vice versa.

By means of the method according to the invention, it is possible for candles to be produced in a simple and inexpensive manner. Furthermore, the cup-like structure that is left over after the candle is burned is easy to dispose of.

It is preferable for the wick to be connected to the cup-like structure for, during or after the deep-drawing but before the filling of the cup-like structure with the combustible material. The wick and/or the wick holder is preferably adhesively bonded and/or sealed into the cup-like structure. For this purpose, the material of the wick and/or of the wick holder and/or of the cup-like structure is particularly preferably sealable.

In an alternative embodiment, the wick and/or the wick holder is cohesively connected to the material web before, during or after the deep-drawing of said material web. A cohesive connection is realized in particular by means of adhesive bonding, welding and/or sealing.

For example, the wick and/or the wick holder may be provided in the region of the punch of a deep-drawing apparatus and, during the deep-drawing process, is pushed in the direction of the material web and, in the process, connected to said material web in non-positively locking, positively locking and/or cohesive fashion.

The wick is preferably connected to the wick holder in positively locking, non-positively locking and/or cohesive fashion before, during or after the insertion into the cup-like structure.

In a preferred embodiment, the wick holder is formed in a recess of the cup-like structure. It is particularly preferable for the material from which the wick holder is produced to be moulded, in particular poured, into the recess in the base, and for the wick to be inserted into the wick holder simultaneously or subsequently. It is very particularly preferable for the wick to be fixed until the material of the wick holder has solidified.

In one preferred embodiment, the wick holder is pressed into a recess of the cup-like structure. It is particularly preferable for the wick holder to be moulded, in particular poured and/or sprayed and/or pressed, into the recess of the cup-like structure.

In a further preferred embodiment, the cup-like structure has, in the base region, an opening into which the wick and/or the wick holder is inserted in positively locking, non-positively locking and/or cohesive fashion. It is particularly preferable for the wick and/or the wick holder to be inserted from below. Alternatively, the wick and/or the wick holder is inserted into the opening from above. It is very particularly preferable for the wick and/or the wick holder to subsequently be connected in positively locking, non-positively locking and/or cohesive fashion to the opening or to the cup-like structure material adjoining the opening. In particular, the wick holder is connected to the opening, or to the material adjoining the opening, by welding, pressing, crimping, adhesive bonding and/or upsetting.

In one preferred embodiment, the wick is provided as an endless band on which wick holders are provided, in particular at regular intervals. The wick holders are particularly preferably formed on the wick. It is very particularly preferably provided that the endless band is guided through the opening from above or below, the wick holder and/or the wick is connected to the cup-like structure, and the wick is cut to length.

In one preferred embodiment, for each cup-like structure, a wick equipped with a wick holder is inserted into the cup-like structure by a wick supply means in a first step, and in a second step, said wick equipped with a wick holder is connected to the cup-like structure in positively locking and/or non-positively locking fashion, in particular by pressing and/or upsetting.

In one preferred embodiment, a moulding means is filled with the material from which the wick holder is produced, a wick is arranged in the moulding means and/or in the material, and the material is hardened, and the wick with the wick holder formed thereon is removed from the moulding means and connected to the cup-like structure or the material web. It is particularly preferable for the material to be at least partially in a liquid or pasty state during the filling process. It is very particularly preferable for the moulding means to be cooled and/or irradiated, for example by means of ultraviolet radiation, at least after the filling process and/or until the removal of the wick holder.

It is preferable for the combustible material to be in the form of a liquid or pasty medium when the cup-like structure is filled therewith, said combustible material hardening in said cup-like structure. The filling of the cup-like structures with the combustible material is preferably performed by means of one filling nozzle per cup-like structure, and particularly preferably at multiple cup-like structures simultaneously.

It is preferable for the cup-like structures to be cooled before, during and/or after the filling thereof with the combustible material, in order to accelerate the hardening of the combustible material.

The present invention also relates to a deep-drawing apparatus, having a forming station which forms cup-like structures into a material web by means of deep drawing, wherein said deep-drawing apparatus has a wick supply means that connects one wick per cup-like structure directly or indirectly to the material web or to the cup-like structure.

In one preferred embodiment, the wick supply means is configured such that, by means thereof, a wick which is provided as an endless band and which is provided, in particular at regular intervals, with wick holders is led through an opening of the cup-like structure, and the wick is cut to length. For this purpose, the wick supply means particularly preferably comprises a means for cutting the wick to the respectively desired length. It is very particular preferable for the wick to be cut to length after the connection of the wick and/or of the wick holder to the material web or to the cup-like structure.

In one preferred embodiment, the wick supply means comprises a positioning means which provides wicks equipped with wick holders and, in a first step, for each cup-like structure, positions a wick with wick holder in the cup-like structure and, in a second step, connects the wick holder and/or wick to the cup-like structure in positively locking, non-positively locking and/or cohesive fashion. It is particularly preferable for the positioning means to have a centring means, in particular a centring disk, which is provided on the positioning means such that, by means of a positively locking and/or non-positively locking connection of the centring means to the cup-like structure, the wick and the wick holder are positioned at a predetermined location in each cup-like structure.

It is preferable for the positioning means to comprise two plates arranged substantially parallel to one another, which plates are at least partially movable in particular perpendicular to their common main plane of extent, and at least one pipe element which extends through openings in the plates and which connects the two plates and in which at least one wick with wick holder is provided. It is particularly preferable for the main direction of extent of the pipe element to be arranged perpendicular to the main plane of extent of the plates, and is very particularly preferable for the diameter of the pipe element to substantially correspond to a largest diameter of the wick holder.

It is preferable for the pipe element to have, at its end facing toward the cup-like structure, a closing means which between an open position, in which a wick with wick holder can exit the pipe element past the closing means, and a closed position, in which the wick and the wick holder are held in the pipe element and in which the closing means can exert a force on a wick and/or wick holder positioned in the cup-like structure such that positive locking and/or non-positive locking is effected between the cup-like structure and the wick and/or the wick holder.

It is preferable for a spring means, in particular a spiral spring, to be arranged between the plates.

The plates are preferably coupled to the closing means such that a movement of at least one of the plates moves the closing means between the open position and the closed position. It is particularly preferable for the plates to be coupled to the pipe element such that a further movement of at least one of the plates moves the pipe element between a first position and a second position, wherein in the second position, a force is exerted on a wick and/or wick holder positioned in the cup-like structure.

In one preferred embodiment, the wick supply means and/or the deep-drawing apparatus is assigned a preparation station which comprises a holding apparatus and a forming means, wherein the holding apparatus and the forming means are configured such that the holding apparatus withdraws a wick with wick holder formed thereon from the forming means, wherein it is particularly preferable for the forming means to be filled, by means of a dosing unit, with a material from which the wick holder is produced, wherein a wick is inserted into the forming means and/or the material and the material is hardened. It is very particularly preferable for a transportation means, in particular a rotary disk, to be provided, which transportation means has a multiplicity of forming means. Alternatively or in addition, the transportation means is a linear guide, for example an endless belt, which has the multiplicity of forming means.

The transportation means is preferably driven such that, in a continuous manner, wick holders are formed onto wicks and withdrawn from at least one forming means of the transportation means. It is particularly preferable for the wick holders to be formed on the wicks in each case sequentially or in batches. Here, “in batches” should be understood to mean that in each case multiple wick holders are formed onto wicks simultaneously.

The statements made regarding this subject of the present invention apply equally to the other subjects of the present invention and vice versa.

It is preferable for the wick to be connected to the material web directly or indirectly, preferably before the deep drawing of the foil web. The wick is connected to the cup-like structure during or after the deep-drawing process.

The deep-drawing apparatus preferably also has a means for cutting the wick to the respectively desired length.

Furthermore, the deep-drawing apparatus preferably has means for filling each cup-like structure with a liquid and/or or pasty combustible material. It is preferable for several such means to be provided, such that several cup-like structures can be filled simultaneously.

The deep-drawing apparatus preferably has a cooling apparatus by means of which the combustible material can be cooled after the respective cup-like structure has been filled therewith.

Yet a further subject matter of the present invention is a deep-drawing apparatus, having a forming station which forms cup-like structures into a material web by means of deep drawing, wherein said deep-drawing apparatus has a loading station which places in each case one complete candle into a cup-like structure and connects said candle to the cup-like structure if appropriate in positively locking and/or non-positively locking fashion.

Yet a further subject matter of the present invention is an apparatus that delivers complete prefabricated magazines that have a multiplicity of cup-like structures. A wick may already be provided in each of said cup-like structures. The apparatus furthermore has a means with which a wick can be placed into each cup-like structure and/or with which each cup-like structure is filled with the combustible material. The prefabricated magazine may already have the predetermined breaking points for separating-off purposes. The apparatus may also have a loading apparatus with which complete candles are placed into the cup-like structures.

It is preferable for the magazines to be delivered in stacked form. In one preferred embodiment, the apparatus therefore has a separation apparatus that separates the magazines.

The inventions will be explained below on the basis of FIGS. 1 to 14.

These explanations are merely exemplary and do not restrict the general concept of the invention. The explanations apply equally to all subjects of the present invention.

### BRIEF DESCRIPTION OF THE DRAWINGS

FIG. 1 shows the candle according to the invention.

FIG. 2 shows the candle magazine according to the invention.

FIGS. 3 and 4 show exemplary embodiments of the cup-like structure.

FIG. 5 shows a recess for the wick or the wick holder.

FIG. 6 shows the candle magazine in a tubular-bag-type packaging.

FIG. 7 shows the packaging machine according to the invention.

FIGS. 8a, 8b and 9a, 9b show exemplary embodiments of the cup-like structure and of the wick or wick holder.

FIG. 10 shows an embodiment of the wick and of the wick holder.

FIG. 11 shows an embodiment of the preparation station.

FIG. 12 shows an embodiment of the positioning means.

FIG. 13 shows a perspective view of the positioning means.

FIGS. 14a, 14b, 14c show the positioning means in different positions.

### DETAILED DESCRIPTION

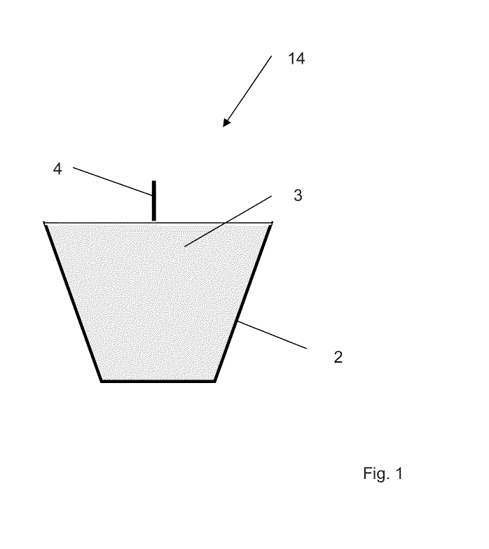

FIG. 1 shows the candle 14 according to the invention which is composed of a combustible material 3, for example a wax, a wax-like material or a technical wax mixture, in which a wick is provided. According to the invention, the combustible material 3 and the wick 4 are provided in a deep-drawn cup-like structure 2. The cup-like structure 2 is preferably manufactured from a material which is non-combustible and/or of low flammability, in this case from a plastic. Is particular preferable for said plastic to be combustible, such that no unnecessary residues remain after the candle 14 has been burned.

FIG. 2 shows the candle magazine 1 according to the invention. Said candle magazine is in this case manufactured from a plastics foil into which a multiplicity of cup-like structures 2 have been formed, in particular simultaneously, by deep drawing. In each of said cup-like structures 2 there is provided a candle 14 composed of a combustible material 3 and a wick 4. Each cup-like structure 2 may be closed off by means of a cover foil 6 which is connected, in particular by sealing, to the candle magazine 1. Furthermore, a predetermined breaking point may be provided in each case between two cup-like structures 2, thus enabling a user to separate off the cup-like structures 2 with the candles 14 situated therein, such that in each case one candle 14 as per FIG. 1 is obtained. The candle 14 situated in the magazine 1 may be used together with the cup-like structure 2, that is to say the candle 14 burns in the cup-like structure 2, thus preventing run-off of the combustible material 3 which liquefies as the candle 14 is burned. Alternatively, however, it is also conceivable for the candle is 14 to be removed from the magazine 1 or the cup-like structure 2 before being burned. This form of use is expedient in particular in the case of so-called floating candles, refill packs or refill candles. The user then preferably presses the candle 14 out of the cup-like structure 2, preferably overcoming a corresponding positive locking and/or non-positive locking action.

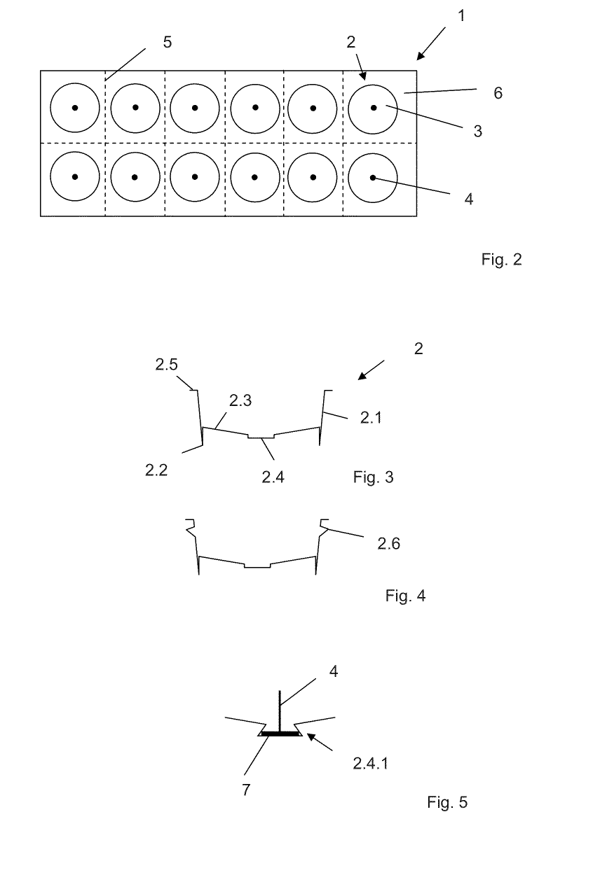

FIG. 3 shows a first embodiment of the cup-like structure 2. Said cup-like structure has a side wall 2.1, preferably a side wall which is inclined with respect to the vertical, wherein the cross section of the cup-like structure 2 preferably tapers toward a base region 2.3. Furthermore, the cup-like structure 2 has a base region 2.3 which, in the present case, is inclined relative to the horizontal in the direction of the centre of the cup-like structure 2, such that the liquefied combustible material 3 flows in the direction of the wick 4. It is preferable for a recess or protuberance, in this case a recess 2.4, to be provided on the base region 2.3, in which recess the wick 4 and/or a wick holder 7 can be arranged. The wick 4 and/or the wick holder 7 are preferably connected to the base region 2.3, in particular to the recess 2.4, in positively locking, non-positively locking and/or cohesive fashion. The recess and/or protuberance 2.4 serves to prevent the wick 4 from departing from its centred position during the filling with the combustible material 3 and/or as the candle 14 is burned. Furthermore, the base region 2.3 and/or the side wall 2.1 are preferably provided such that the base region 2.3 in which the wick 4 and/or the wick holder 7 is situated is spaced apart from the rest surface 2.2. It is ensured in this way that the rest surface 2.2 on which the candle 14 stands is not damaged as the candle 14 is burned. In the present case, this is achieved by virtue of the side wall 2.1 being deep-drawn to a greater extent than the base region 2.3, 2.4. Alternatively or in addition, however, the base region 2.3, 2.4 may also have protuberances with which the cup-like structure 2 stands on the rest surface 2.2 and which generate a spacing between the base region 2.3, 2.4, in which the wick 4 or the wick holder 7 are situated, and the rest surface 2.2. In the present case, opposite the base region 2.3, the side wall 2.1 has an edge 2.5, in this case an encircling edge, which may serve as a sealing surface for a cover foil 6 that may be provided. Furthermore, however, said edge 2.5 of the cup-like structure 2 also provides additional stability. In particular, it is preferably possible for the side wall 2.1 to have additional recesses and/or protuberances, in particular in order to increase the stability thereof.

FIG. 4 shows a further embodiment of the cup-like structure 2. Reference may be made substantially to the statements made regarding FIG. 3. In the present case, there is additionally provided in the side wall 2.1 a positive locking and/or non-positive locking means 2.6, in this case an undercut, which interacts in positively locking and/or non-positively locking fashion with the combustible material 3 of the candle 14. Said positive locking and/or non-positive locking action serves to prevent the combustible material 3 and the wick 4, that is to say the candle 14, from inadvertently becoming detached from the cup-like structure 2. The positive locking and/or non-positive locking action is achieved in particular by virtue of liquid combustible material 3 being introduced into the cup-like structure 2 and solidifying there. The positive locking and/or non-positive locking action is generated during the solidification process. Said positive locking and/or non-positive locking means 2.6 is preferable in particular if the candle 14 is to be removed from the candle magazine 1 or the cup-like structure 2 before being burned. For this purpose, it is for example the case that a pressure is exerted on the base region, which pressure pushes the candle 14 out of the cup-like structure 2. Here, the positive locking and/or non-positively locking action between the candle 14 and the cup-like structure 2 is eliminated, preferably with a snapping action, and the candle 14 can be used for example as a floating candle. This embodiment is preferable in particular if the candle magazine 1 is used merely as a transportation and/or storage container for the candle 14.

FIG. 5 shows details of the recess and/or protuberance 2.4 for the wick 4. It can be clearly seen that the side walls 2.4.1 of the recess are provided with an undercut such that a positively locking and/or non-positively locking connection is produced between the wick 4 or wick holder 7 and the base region of the cup-like structure 2. Said recess, or a recess of any other form, may for example be produced by virtue of the wick holder 7 being pressed into the plastics foil, for example by means of a punch, during the deep drawing of the cup-like structure 2, with the desired deep-drawn form being produced in the process. When the punch is removed, the wick 4 and/or the wick holder 7 then remains in the thus completed packaging cup-like structure, and is preferably connected to the latter in positively locking and/or non-positively locking fashion.

It is also possible for a cohesive action to be generated between the wick 4 or wick holder 7 and the base region 2.3, 2.4 of the cup-like structure 2, for example by means of sealing or adhesive bonding.

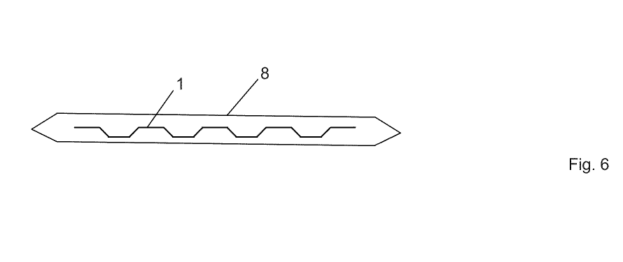

FIG. 6 shows the candle magazine 1 which, in the present case, is provided in a packaging, in particular a plastics packaging 8, in particular in a tubular-back-type packaging. In addition to said packaging, the magazine 1 may also have a cover foil 6. This preferred embodiment of the present invention is desirable in particular if scented candles of different scents are situated in the candle magazine 1. The cover foil 6 prevents the scents of the candles from assimilating.

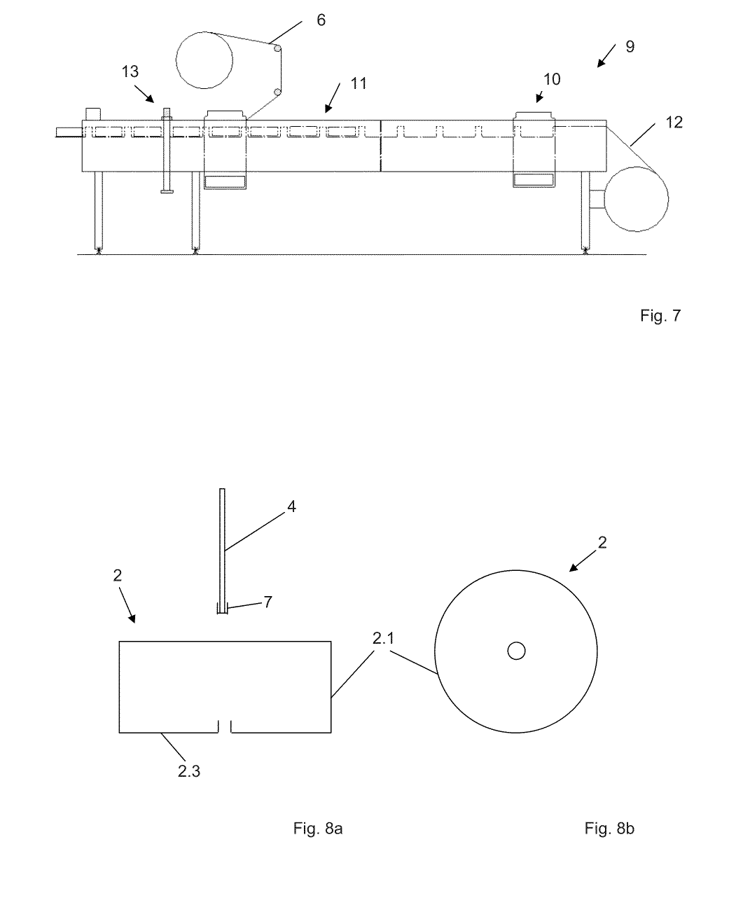

FIG. 7 shows the deep-drawing apparatus 9 according to the invention by means of which the candle magazine 1 according to the invention or the candle 14 according to the invention can be produced. In the case of this deep-drawing apparatus 9, a material web 12, in this case a foil web 12, moves along the deep-drawing apparatus 9, in this case from right to left. Said transportation is preferably continuous though may also take place in intermittent, that is to say cyclic fashion. The cup-like structures 2 are formed into said material web 12 by deep drawing in a forming station 10. Is preferable for a multiplicity of cup-like structures 2 to be situated adjacent one another, in particular in the form of a matrix, such that multiple cup-like structures 2 are deep-drawn simultaneously. The deep drawing is preferably performed by virtue of the material web 12 initially being heated and then being formed into a die by means of negative pressure and/or by means of a punch. A wick 4 is fastened in the cup-like structure 2 or to the foil web 12 before, during or after the deep-drawing process. A filling station 11 is provided downstream of the forming station 10 and after the point at which the wick 4 is inserted. In the filling station 11, the cup-like structure 2 is filled with a liquid or pasty combustible material 3, which subsequently hardens in the cup-like structure 2. It is however alternatively also possible for an already complete candle 14 to be placed in the cup-like structure 2. This is referred to as a loading station 11.

It is also possible for already prefabricated magazines 1 to be delivered to the apparatus. In this case, the forming station 10 may be omitted, and is preferably replaced by an unstacking means.

In a preferred embodiment, the candle magazine 1 is then closed off by means of a cover foil 6 which is fastened, preferably by means of cohesive connection, in particular by means of sealing, to the foil web 12 from which the cup-like structures 2 are manufactured. The candle magazines 1 or the candles 14 are subsequently separated by means of a transverse and/or longitudinal cut and may then optionally also be provided with an additional packaging, for example in a so-called tubular bag machine.

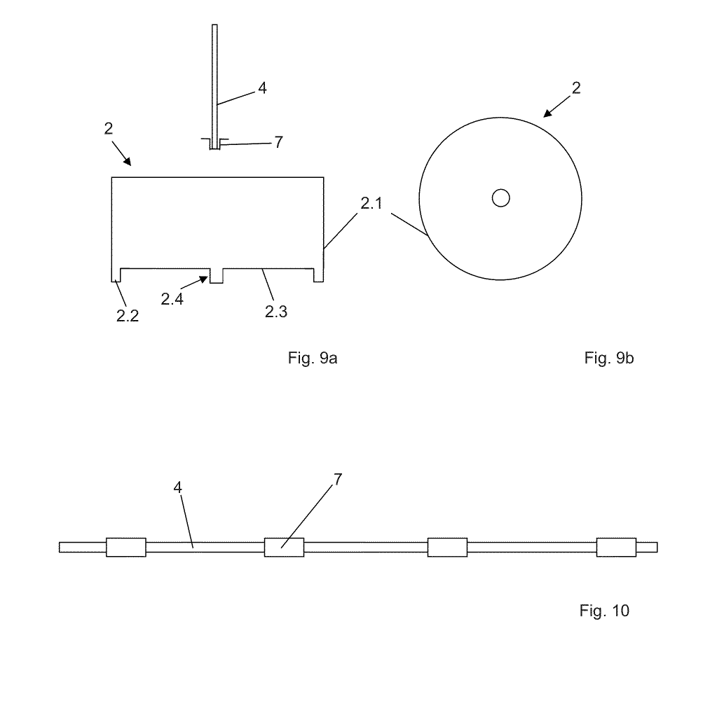

FIGS. 8a, 8b and 9a, 9b show exemplary embodiments of the cup-like structure 2 and of the wick holder 7. Here, in FIGS. 8a and 9a show schematic sectional drawings, and FIGS. 8b and 9b show plan views. Reference is generally made to the statements made with regard to FIGS. 3 and 4. Here, it is the case in particular that FIGS. 8a and 9a show the situation before the wick 4 and the wick holder 7 are connected to the cup-like structure 2.

The cup-like structure 2 as per the embodiment illustrated in FIG. 8a has, in the base region 2.3, an opening into which the wick holder 7 is inserted. In this case, the wick 4 is already connected to the wick holder 7, though it is alternatively also possible for the wick 4 to be inserted into the wick holder 7 in positively locking, non-positively locking and/or cohesive fashion only after the wick holder 7 has been connected to the cup-like structure 2.

The wick holder 7 is preferably inserted into the opening of the cup-like structure 2 from above or below. The wick holder 7 is subsequently connected to the cup-like structure 2 for example by welding, pressing and/or crimping, in particular when the base region of the wick holder 7 is arranged/with the base region 2.3. For this purpose, it is preferable for the wick holder 7 and the cup-like structure 2 to be composed of the same material, in this case plastic, for example. It is alternatively also possible for the wick holder 7 and/or the wick 4 to be connected to the cup-like structure merely in non-positively locking and/or positively locking fashion, in particular by pressing. In this case, the opening of the cup-like structure 2 preferably has a slightly smaller cross section than the wick holder 7. It is also for example conceivable that, after the wick holder 7 and/or the wick 4 has been arranged in the opening, the punch of the deep-drawing apparatus 9 upsets the material in the region of the opening such that a positive locking and/or non-positive locking action is generated between the material in the region of the opening and the wick holder 7 and/or the wick 4.

In particular, the cup-like structure 2 as per the embodiment illustrated here has substantially vertical wall elements in the region of the opening, by means of which wall elements the connection is established between the cup-like structure 2 and wick holder 7. Alternatively, the wall elements are inclined, wherein the resulting weir-like structure serves in particular to predefine a preferential direction for the insertion of the wick 4 and/or of the wick holder 7.

FIG. 8b shows a plan view in which the cup-like structure 2 with the central opening can be clearly seen.

In the embodiment illustrated in FIG. 9a, the cup-like structure 2 has recesses or protuberances. In an edge region of the cup-like structure 2, a recess or protuberance of said type is provided in this case as a groove-like rest surface 2.2, and in the central region of the cup-like structure 2, a recess or protuberance 2.4 serves as a receptacle for the wick holder 7 and/or the wick 4. It is also the case here that the wick 4 is preferably inserted into the wick holder 7 before the connection to the cup-like structure 2 is established. Alternatively, the central recess or protuberance 2.4 is filled with a liquid or pasty material, the wick 4 is inserted into said material, and the material is caused to solidify, such that the recess or protuberance 2.4 serves as a mould for the wick holder 7.

In the embodiment illustrated here, however, the wick holder 7 is pressed into the recess or protuberance 2.4 and is preferably subsequently welded to or sealed with the cup-like structure 2.

At its upper edge, the wick holder 7 has, in this case, a flange-like edge region which serves as a combustion stopper. When the wick 4 has burned down as far as said edge region, the flame is extinguished, such that melting and/or excessive heating of the base region 2.3 of the cup-like structure 2 is prevented. For this purpose, the wick holder may for example additionally or alternatively have a flame-extinguishing coating.

FIG. 9b shows a plan view of the cup-like structure 2 according to the invention. In particular, said figure shows the recess or protuberance 2.4 in the centre. The cup-like structures 2 illustrated in FIGS. 8 and 9 are of circular form. However, any other desired shape, for example square, triangular, elliptical and/or polygonal, is also possible.

FIG. 10 shows an embodiment of the wick 4 and of the wick holder 7 before the connection to the cup-like structure 2 or to the material web 12 is established. Here, the wick 4 is provided in the form of an endless band on which wick holders 7 are provided at regular intervals. Said wick holders are for example formed onto the wick 4. The wick 4 thus resembles a string of pearls. For stabilization and ease of handling, the wick 4 is for example provided with a coating composed of a hard wax.

A wick supply means is then for example configured such that the endless band is guided through the opening of a cup-like structure 2 as per the embodiment described in conjunction with FIGS. 8a and 8b, the wick 4 and/or wick holder 7 is connected to the cup-like structure 2 in positively locking, non-positively locking and/or cohesive fashion, in particular by pressing, crimping, welding and/or sealing, and the wick 4 is cut to length.

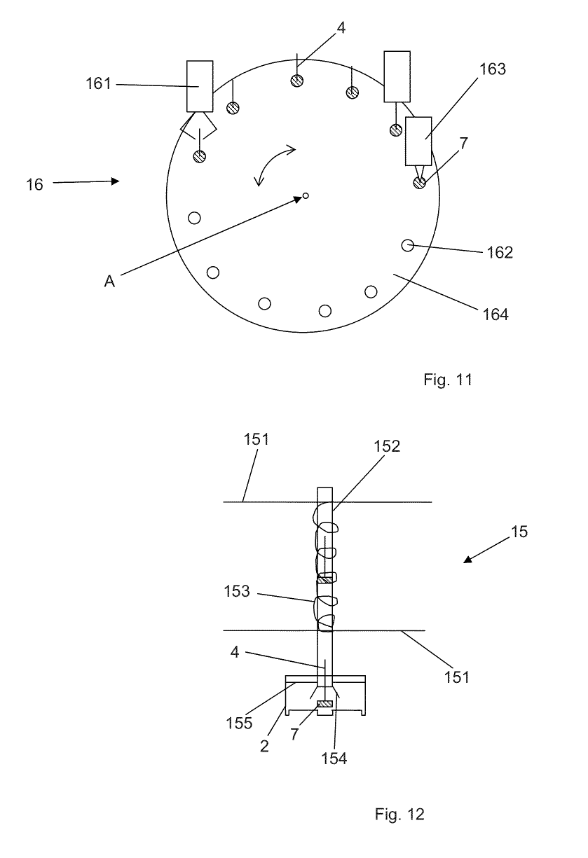

FIG. 11 illustrates an embodiment of the preparation station 16. A transportation means, in this case a rotary disk 164, which is driven in rotation about a vertical axis A arranged in its centre, has a multiplicity of forming means 162, in this case depressions. A dosing unit 163 fills a forming means 162 with a material from which the wick holder 7 is produced. Here, the material is for example in liquid or at least partially flowable, for example pasty, form. A wick 4 is subsequently inserted into the material for the forming means 162 and the material is caused to harden.

Here, the material may harden of its own accord, though the hardening may also be assisted, for example by virtue of the forming means 162 being cooled in the case of a wax or wax-like material. Alternatively or in addition, the hardening may be externally induced. For example, a suitable plastic may for example be hardened by being subjected to ultraviolet radiation.

A holding apparatus 161 grips the wick 4 and/or the wick holder 7 formed thereon, withdraws it from the forming means 162, and conveys it to the deep-drawing apparatus 9.

Here, the rotary disk 164 may be moved in continuous or stepped fashion. It is clear that the preparation station may also be provided such that multiple dosing units 163 simultaneously fill multiple forming means 162. In this case, it is likewise the case that multiple holding apparatuses 161 are provided or that the holding apparatus 161 is designed such that it can simultaneously withdraw multiple wicks 4 and/or wick holders 7.

Alternatively, the transportation means is a linear guide such as, for example, an endless conveyor belt. This is advantageous if a large number of wick holders 7 are to be formed onto wicks 4 simultaneously.

FIG. 12 illustrates an embodiment of the positioning means 15. The positioning means 15 comprises two plates 151 which are arranged parallel to and spaced apart from one another. The plates 151 are connected by a pipe element 152 which is guided in each case through openings in the plates 151 and is oriented perpendicular to the plates. Here, the pipe element 152 is dimensioned such that exactly one wick 4 with wick holder 7 can be guided in the interior of the pipe element 152, that is to say, for example, the internal diameter of the pipe element 152 corresponds to a largest diameter of the wick holder 7.

The plates 151 and the pipe element 152 are coupled, in this case inter alia by means of a spiral spring 153 which is arranged between the plates 151 and around the pipe element 152. The coupling may additionally or alternatively be realized by way of positive locking and/or non-positively means, for example by means of a slotted guide, or by means of a cohesive connection. The spring means advantageously makes an automatic restoring action possible.

The plates 151 are in this case movable toward one another and away from one another independently of one another. It is thus possible here for the plates 151 to assume in each case a first position and a second position.

The pipe element 152 has, on one end, a closing means 154 that can be adjusted at least between an open position and a closed position. The illustration here shows the open position. In this position, the wick 4 with wick holder 7 falls out of the pipe element 152 under the force of gravity. In the closed position, the wick 4 and wick holder 7 are held in the pipe element 152 such that they cannot fall out.

In order that the wick 4 and wick holder 7 are reproducibly always positioned in the centre of a cup-like structure 2, the positioning means 15 has a centring means, in this case a centring disk 155, which is arranged, for example in positively locking, non-positively locking and/or cohesive fashion, on the pipe element 152 in the region of the closing means 154. The mode of operation of the positioning means 15 will be explained in detail on the basis of FIGS. 14a to 14c.

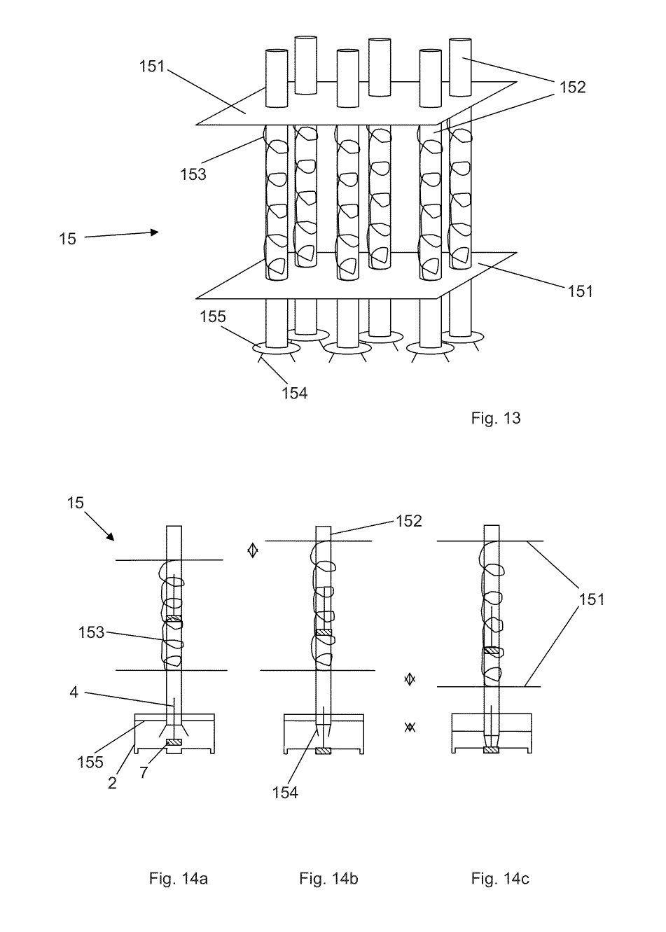

FIG. 13 shows a perspective view of the positioning means 15. In the embodiment illustrated here, multiple pipe elements 152 are provided between the plates 151, such that a multiplicity of cup-like structures 2 can be supplied with wicks simultaneously. The movement of the plates 151 is transmitted synchronously to all of the pipe elements 152 by means of the spiral springs 153.

FIGS. 14a, 14b, 14c show the positioning means 15 in different positions. The function of the positioning means 15 will in this case be described, for simplicity, for only one pipe element 152, however the statements also apply to a positioning means 15 as illustrated in FIG. 13.

The positioning means 15 is lowered into a cup-like structure 2. Here, a positive locking and/or non-positive locking action is generated between the side wall 2.1 of the cup-like structure 2 and the centring disk 155, such that the pipe element 152 is centred with respect to the cup-like structure 2. As illustrated in FIG. 14a, the upper plate 151 is now lowered into the second position, as indicated by the double arrow, such that by means of corresponding coupling, the closing means 154 is moved into the open position. A wick holder 4 with wick holder 7 provided in the pipe element 152 falls out into the cup-like structure 2, for example into a recess or protuberance 2.4.

The upper plate 151 is then moved back into the first position, as illustrated in FIG. 14b. Owing to the coupling, the closing means 154 is moved back into the closed position. It is thus no longer possible for a wick 4 or wick holder 7 to fall out, thereby ensuring that only one wick 4 with wick holder 7 is provided in each cup-like structure 2.

Finally, the second, lower plate 151 is moved into the second position, as illustrated in FIG. 14c. As a result, the pipe element 152 is likewise moved in the direction of the cup-like structure 2, whereupon the closing means 154 exerts a force on the wick 4 and/or on the wick holder 7, whereby the wick 4 and/or the wick holder 7 is connected to the cup-like structure 2.

In the embodiment illustrated, the wick 4 and/or wick holder 7 are pressed into a recess or protuberance 2.4 such that a positive locking and/or non-positive locking action is generated. Alternatively or in addition, the side wall 2.4.1 of the recess or protuberance is upset.

The positioning means 15 can then be moved out of the cup-like structure 2, the cup-like structure 2 provided with a wick can be removed, and a cup-like structure 2 to be provided with a wick can be moved under the positioning means, whereupon the described steps are performed again from the beginning.

The upper and lower plates 151 are interchangeable in terms of their functionality. It is clear that the described mechanism is similar to that of a propelling pencil.

Patent claims:

1. Candle magazine, characterized in that said candle magazine has a multiplicity of deep-drawn cup-like structures in which there is provided in each case one candle composed of a combustible material and of a wick.

2. Candle magazine according to claim 1, characterized in that the wick is directly or indirectly connected to the cup-like structure in positively locking, non-positively locking and/or cohesive fashion.

3. Candle magazine according to claim 1, characterized in that each cup-like structure has a base region in which there is provided a recess and/or protuberance in which the wick and/or a wick holder is fastened.

4. Candle magazine according to claim 3, characterized in that the base region is provided so as to be inclined relative to the horizontal at least in sections.

5. Candle magazine according to claim 1, characterized in that a predetermined breaking point is provided between two cup-like structures.

6. Candle magazine according to claim 1, characterized in that the cup-like structure has a means for connecting the combustible material to the cup-like structure in positively locking and/or non-positively locking fashion.

7. Candle having a combustible material and a wick, characterized in that said candle is provided in a deep-drawn cup-like structure.

8. Candle according to claim 7, characterized in that said candle is separated off from a candle magazine according to claim 1.

9. Method for producing a candle according to claim 7, characterized in that the cup-like structure is deep-drawn from a material web, the wick is provided in the cup-like structure, and the cup-like structure is filled with the combustible material.

10. Method according to claim 9, characterized in that the wick is connected to the cup-like structure before, during or after the deep-drawing and/or before the filling of the cup-like structure with the combustible material.

11. Deep-drawing apparatus, having a forming station which forms the cup-like structures into a material web by means of deep drawing, characterized in that said deep-drawing apparatus has a wick supply means that connects one wick per cup-like structure directly or indirectly to the material web or to the cup-like structure.

12. Deep-drawing apparatus, having a forming station which forms the cup-like structures into a material web by means of deep drawing, characterized in that said deep-drawing apparatus has a loading station which places in each case one complete candle into a cup-like structure.
